(19) United States
(12) Patent Application Publication
(10) Pub. No.: US 2013/0009460 A1
(43) Pub. Date: Jan. 10, 2013

(54) METHOD AND APPARATUS FOR ADDING INCREASED FUNCTIONALITY TO VEHICLES

(76) Inventor: Aaron Speach, San Diego, CA (US)

(21) Appl. No.: 13/178,671

(22) Filed: Jul. 8, 2011

(51) Int. Cl. B60L 1/00; H01R 43/00; F16M 13/02

(52) U.S. Cl. 307/9.1; 248/220.21; 29/825

(57) ABSTRACT

An apparatus for providing increased vehicle functionality comprises a dashboard insert comprising a recess and an electrical connector, and a second insert for mating with the recess, the second insert comprising a deformation sized and shaped to receive a mobile computing device. In another embodiment, a method for providing additional functionality to a vehicle comprises installing a dashboard insert into a dashboard, the dashboard insert comprising a recess and an electrical connector, and securing a second insert to the recess, the second insert having an external surface substantially matching the recess and further comprising a deformation substantially matching an external surface of a mobile computing device.

### BACKGROUND

I. Field of Use

The present application relates to the field of vehicle electronics and more specifically to a method and apparatus for adding increased functionality to vehicles, such as vehicle navigation, to a vehicle lacking such functionality.

II. Description of the Related Art

Integrated electronic devices in vehicles have been around for decades. Most popular of these devices is vehicle sound systems, in the past beginning with simple AM/FM radios, to today's complex sound systems employing computer technology. Other examples of in-vehicle electronics include vehicle navigation systems, video entertainment systems, computer-controlled heating and air conditioning systems, controls for intermittent windshield wiper systems, and so on.

Many modern vehicles today are manufactured with such electronic systems pre-installed, driving up the cost of such vehicles. In other cases, vehicles may be manufactured having a small amount of desirable electronic controls/devices, or they may have none at all. In these cases, various add-on devices are available to consumers to upgrade their vehicles to include greater functionality. For example, third-party navigation systems are widely available for vehicles that lack a factory-installed navigation system. These third-party solutions tend to be expensive, not only in initial cost, but also in labor to install such devices.

Another problem with third-party electronic devices is that they are generally designed for one particular purpose. That is, a third-party navigation system may provide vehicle navigation and nothing more. An upgraded stereo might provide MP3 player capability or the ability to play the most up-to-date CDs or DVDs. A video entertainment system may offer the ability to view pre-recorded videos and movies and to possibly play video games. However, each of these systems must be purchased and installed separately, resulting in a relatively large expense to consumers.

Thus, it would be desirable for consumers to be able to cheaply and easily add additional functionality to their vehicles.

### SUMMARY

The embodiments described herein relate to methods and apparatus for adding increased functionality to vehicles.

In one embodiment, an apparatus for providing increased vehicle functionality comprises a dashboard insert comprising a recess and an electrical connector, and a second insert for mating with the recess, the second insert comprising a deformation sized and shaped to receive a mobile computing device.

In another embodiment, a method for providing increased vehicle functionality comprises installing a dashboard insert into a dashboard, the dashboard insert comprising a recess and an electrical connector, and securing a second insert to the recess, the second insert having an external surface substantially matching the recess and further comprising a deformation substantially matching an external surface of a mobile computing device.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates one embodiment of an apparatus for providing additional functionality to vehicles;

FIG. 2 illustrates a mobile computing device installed into a vehicle dashboard via the apparatus shown in FIG. 1;

FIG. 3 illustrates a circuit board located on a rear surface of the dashboard insert shown in FIG. 1;

FIG. 4 illustrates another embodiment of the dashboard insert of FIG. 1;

FIG. 5 is a flow chart illustrating a method for providing low-fuel status information to a vehicle occupant;

FIG. 6 is a plan view of another embodiment of the apparatus for providing additional functionality to vehicles;

FIG. 7 is an illustration of the apparatus of FIG. 6 in operation;

FIG. 8 is a plan view of a rear side of the apparatus shown in FIG. 6;

FIG. 9 is a perspective rear view of the second insert shown in FIG. 1;

FIG. 10 illustrates a rear view of the dashboard shown in FIG. 6; and

FIG. 11 illustrates an exploded view of an embodiment of an apparatus for providing additional functionality to vehicles comprising a display device and additional circuitry.

### DETAILED DESCRIPTION

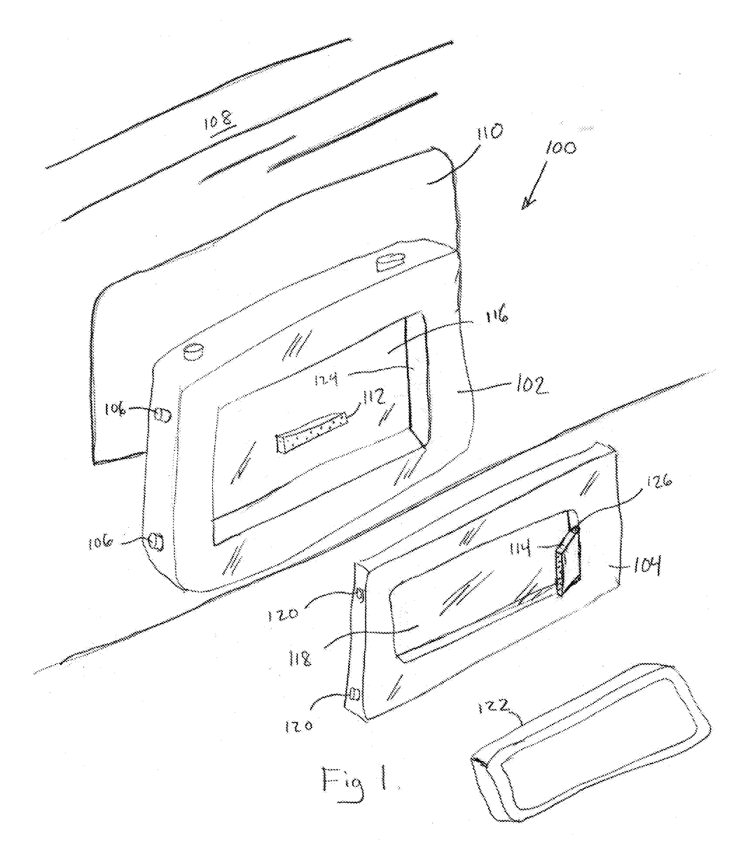

FIG. 1 illustrates one embodiment of an apparatus for providing additional functionality to a vehicle, herein referred to as assembly 100. Assembly 100 comprises dashboard insert 102 and second insert 104. Assembly 100 is used in conjunction with a mobile computing device 122 to provide increased electronic functionality to a vehicle that lacks such functionality and/or to provide enhanced functionality to components that are pre-existing within a vehicle. Such vehicles may include cars, trucks, busses, boats, airplanes, etc.

To provide additional/enhanced functionality, dashboard insert 102 is installed into a convenient physical location, such as a dashboard or console 108, of a vehicle interior. Dashboard insert 102 may be sized and shaped to fit in a pre-designated cutout 110 that is specific to a particular vehicle make or model. In another embodiment, dashboard insert 102 may be placed into a custom-fit cutout 110 in any area of a vehicle that is convenient. For example, most vehicles manufactured today comprise pre-designated areas or cutouts for installing various instrumentation and electronic equipment. These pre-designated areas are generally sized and shaped differently from one vehicle to another. Thus, dashboard insert 102 may be manufactured in a variety of shapes and sizes, each specifically designed to fit a particular one of these pre-designated cutouts. In another embodiment, dashboard insert 102 may be sized and shaped so that one particular design may fit into a variety of vehicle makes and/or models.

In the embodiment shown in FIG. 1, dashboard insert 102 is approximately 7 inches long, four inches wide, and 1 inch deep. Of course, these dimensions can vary, depending on the dimensions of the pre-designated area or custom area that the insert 102 is to be placed. Dashboard insert 102 can be constructed of virtually any rigid or semi-rigid material, such as metal, wood, plastic, polyurethane, rubber, etc. It may be constructed using well-known techniques known in the art. For example, dashboard insert 102 could be formed as a single unit by injection molding or by assembling a number of individual elements.

Dashboard insert 102 further comprises means 106 for attaching dashboard insert 102 to, or into, a vehicle dashboard or console cutout 110. In the embodiment shown in FIG. 1, the means 106 simply comprises a number of knobs spaced along a periphery of dashboard insert 102. During insertion of dashboard 102 into a dashboard or console cutout 110, the means 106 may be positioned behind the perimeter of cutout 110 as dashboard insert 102 and/or cutout 110 is temporarily deformed to allow all of the means 106 to be placed behind the perimeter of cutout 110. In other embodiments, the means 106 comprises raised, beveled tabs, commonly used in the automotive industry, to attach various components together. Other well-known techniques could be used in the alternative.

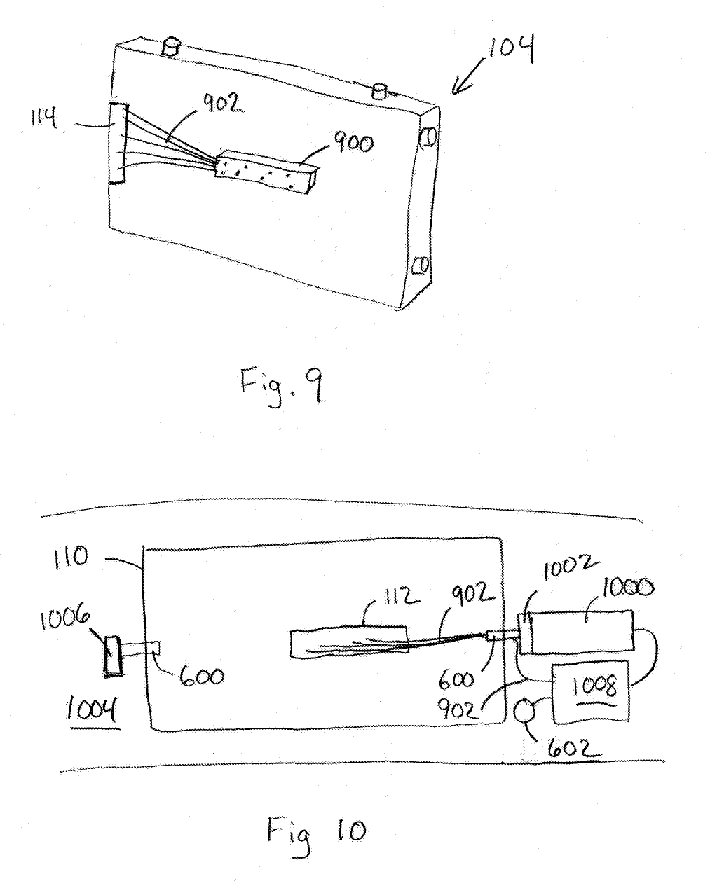

In one embodiment, dashboard insert 102 further comprises connector 112, used to receive electronic signals from mobile computing device 122 via a connector located on the back of second insert 104 (shown as connector 900 in FIG. 9). The connector on the back of second insert 104 is connected to connector 114 via one or more cables, wires, or other means 902 (as shown in FIG. 9) well-known in the art on the back side of second insert 104. This arrangement allows electronic signals to pass between connector 112 and connector 114 when second insert 104 is connected to dashboard insert 102. In another embodiment, connector 112 is designed to mate directly with mobile computing device 122 and connectors 114 and 900 are not used. In this embodiment, connector 112 is typically mounted on side wall 124 and mobile computing device 122 is connected to connector 112 as second insert is placed inside recess 116.

In any case, connector 112 comprises any one of a number of available connectors on the market today, having enough contacts to carry the necessary signals from mobile computing device 122 to a receiving circuit (not shown). In one embodiment, one or more electronic circuits or devices are located on a back side of dashboard insert 102, typically comprising a variety of integrated circuits and/or discreet electronic devices located on a circuit board. In other embodiments, these circuits/devices can be located in or on another portion of dashboard insert 102 or somewhere in or on the vehicle.

In one embodiment, connector 114 comprises a hinge 126 that allows connector 114 to swivel to a first position (shown in FIG. 1) to more easily receive the connector mobile computing device 122 and to a second position as second insert 104 is secured within recess 116. The hinge may additionally comprise a spring that forces connector 114 to the first position when second insert 104/and or mobile computing device 122 is not present. In an embodiment where connector 112 connects directly to the mobile computing device 122, connector 112 may be equipped with the aforementioned hinge or hinge-spring combination.

Dashboard insert 102 further comprises a depression, recess, alcove, cutout, or indentation 116 (herein referred to as recess 116), sized and shaped to receive second insert 104, as shown. The formation of recess 116 substantially matches an outer surface of second insert 104, so that second insert 104 fits substantially within recess 116.

Second insert 104 is designed to mate with recess 116 as well as accommodate mobile computing device 122. The mobile computing device 122 is captured within a depression, recess, alcove, cutout, or indentation 118 (herein referred to as recess 118) sized and shaped for an exterior of one of a variety of mobile computing devices 122 available in the market. Such mobile computing devices 122 comprise smartphones such as the Apple iPhone, the Motorola Droid, the Samsung Galaxy, etc., and tablet computers such as the Apple iPad, Motorola Xoom, the Asus EEE Pad MeMO, and so on. The mobile computing device 122 may be held in place by any number of well-known techniques, such as by a friction fit between the external surface of the mobile computing device 122 and the recess 118, the use of tabs, grooves, or other mechanical interference techniques, etc.

Second insert 104 additionally comprises means 120 for removably attaching second insert 104 to, or into, dashboard insert 102. In the embodiment shown in FIG. 1, the means 120 simply comprises a number of knobs spaced along a periphery of second insert 104. During insertion of second insert 104 into dashboard insert 102, the means 120 are positioned behind the perimeter of dashboard insert 102 (or into recesses formed along an inside perimeter of recess 116) and temporarily deformed to allow the means 120 to be placed behind the perimeter of recess 116 (or into the recesses). In other embodiments, the means 120 comprises any well-known techniques to secure second insert 104 inside dashboard insert 102.

In the embodiment shown in FIG. 1, second insert 104 is approximately 5.5 inches long, 3.5 inches wide, and ⅝ inch deep. Recess 118 measures approximately 4.5 inches long, 2.4 inches wide, and ⅜ inch deep. Of course, these dimensions can vary, depending on the dimensions of the particular mobile computing device 122, as well as other factors. Second insert 104 can be constructed of virtually any rigid or semi-rigid material, such as metal, wood, plastic, polyurethane, rubber, etc. It may be constructed using well-known techniques known in the art. For example, second insert 104 could be formed as a single unit by injection molding or by assembling a number of individual elements.

The advantage of assembly 100 is that a person possessing a smartphone or tablet computer can use the smartphone or tablet computer to add additional functionality to a vehicle lacking such functionality, without having to purchase expensive, uni-functional after-market devices.

Once dashboard insert 102 has been placed into dashboard 108, a vehicle occupant may connect mobile computing device 122 to the vehicle via dashboard insert 102 and second insert 104. The occupant's mobile computing device 122 may be disposed within recess 118 on second insert 104, where it is held within recess 118 by mechanical means (such as a friction fit, tabs, etc.) for preventing mobile computing device 122 from becoming easily dislodged. The mobile computing device 122, in one embodiment, may be further retained by connector 114 as a connector located on mobile computing device 122 is inserted into one end of connector 114. In another embodiment, connector 114 is not used and mobile computing device 122 is placed within second insert 104 and connected directly to connector 112.

Second insert 104 may then be placed within recess 116 of dashboard insert 102, where it is held in place via mechanical means, i.e., a friction fit, tabs, etc. In an embodiment where connector 114 is not used, the connector located on mobile computing device 122 is inserted into connector 112 so that signals to/from mobile computing device 122 can be sent/provided to electronic circuitry located in or on the vehicle. In an embodiment where connector 114 is used, connector 900, located on the back side of second insert 104, mates with connector 112 so that one or more electronic signal paths are provided between mobile computing device 122 and electronic circuitry residing on dashboard insert 102, in or on the vehicle, or both.

Use—Navigation

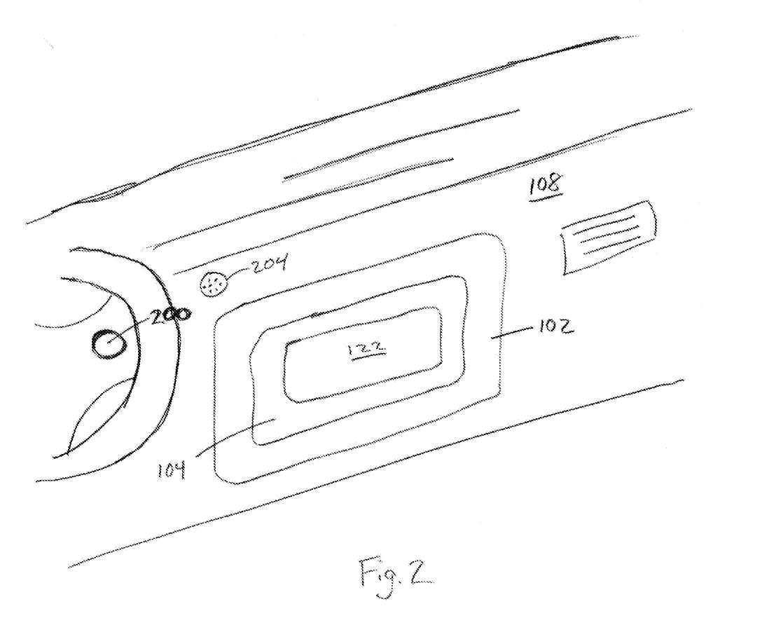

FIG. 2 illustrates mobile computing device 122 installed into a vehicle dashboard 108 via assembly 100 and, in this application, used to provide vehicle navigation to a vehicle occupant. Many of today's mobile computing devices 122 are capable of providing such navigation to individuals. Typically, this functionality comprises pre-installed software or a user-downloadable application from a network source (such as Apple's iTunes or Google's Android Market). The navigation functionality may comprise mapping functions, directions, landmark location, voice-control, and many other desirable features. When such mobile computing device, such as mobile computing device 122, is placed within assembly 100, vehicle occupants are provided with a convenient navigation system associated with the vehicle.

In one embodiment, a remote switch 200 is used to initiate a vehicle navigation software application residing on the mobile computing device 122. Remote switch 200 comprises one of a number of well-known remote switches that uses wireless or wired technology to communicate with mobile computing device 122. For example, remote switch 200 may comprise a Bluetooth, RF, infrared, or other well-known wireless communication technology, or it may be connected via one or more wires to mobile computing device 122. The switch may be located on any vehicle interior surface, such as on a steering wheel, visor, dashboard, or any other convenient location.

The switch 200 sends one or more electrical signals to mobile computing device 122, such as a signal to launch an application, such as a vehicle navigation application. The switch could be used to send other signals to mobile computing device 122, each of these other signals used to launch a different application residing on mobile computing device 122.

Upon receipt of one of such signals from switch 200, mobile computing device 122 launches, or activates, one of a number of available software applications relating to vehicle navigation resident on mobile computing device 122. Once the application is launched, it may be operated using a user-interface located on mobile computing device 122, or it may be operated using voice commands, or a combination of both. In one embodiment, the signal received from switch 200 both activates the vehicle navigation application as well as enables voice commands. In another embodiment, a second signal received from switch 200 enables voice commands. In either case, when a vehicle occupant wishes to either activate the vehicle navigation application resident on the mobile computing device 122 and/or use voice commands to control the functionality of the vehicle navigation application, the vehicle occupant depresses or otherwise activates switch 200. The signal or signals sent by switch 200 as a result of the occupant's initiation are received by mobile computing device 122 and used to either launch the vehicle navigation application and/or allow the vehicle navigation application to accept voice commands.

Once voice commands are enabled, the vehicle occupant may speak verbal commands into a microphone 202, which may be remotely located from mobile computing device 122. In another embodiment, a pre-existing microphone resident on mobile computing device 122 is used to accept voice commands. The voice commands provide instructions for operation of the vehicle navigation application.

Use—Media

In another embodiment, in addition or alternative to the vehicle navigation application described above, the assembly 100 can be used to provide media, such as music and/or visual entertainment, to vehicle occupants.

In this embodiment, mobile computing device 122 is used to provide music, video, and/or other media to vehicle occupants via assembly 100. For example, music or other media may be stored within mobile computing device 122 and played using software resident on mobile computing device 122, such as Apple Incorporated's popular iTunes application. The application provides an electronic signal representative of the music and/or media to a mobile computing device 122 input/output connector that is connected to connector 112 of dashboard insert 102, either directly, as described in one embodiment, or through connectors 112, 114, and 900, as previously described in another embodiment.

In any case, the electronic signal representing the music/media is provided to circuitry used to amplify and otherwise control the electronic signal. In one embodiment, the amplification and control circuitry is provided by a previously-installed device, such as a car stereo, amplifier, video playback device, and/or other media device. A cable or wiring harness connected between connector 112 and the previously-installed device provides the electronic signal from mobile computing device 122 to the previously-installed device. In one embodiment, the cable/wiring harness comprises a connector on one end that interfaces with a connector located on the previously-installed device, for instance a USB connector, RCA jacks, an audio connector, etc. In another embodiment, the cable/wiring assembly is installed into wiring or circuitry inside of, or associated with, the pre-existing device. The electronic signal from mobile computing device 122 is used by the previously-installed device as an external input, whose volume or other features can be adjusted using circuitry within the previously-installed device. An amplified representation of the electronic signal may then be provided to speakers located in the vehicle if the electronic signal represents audio information or it may be displayed on a display of the pre-existing device if the electronic signal represents video or other media.

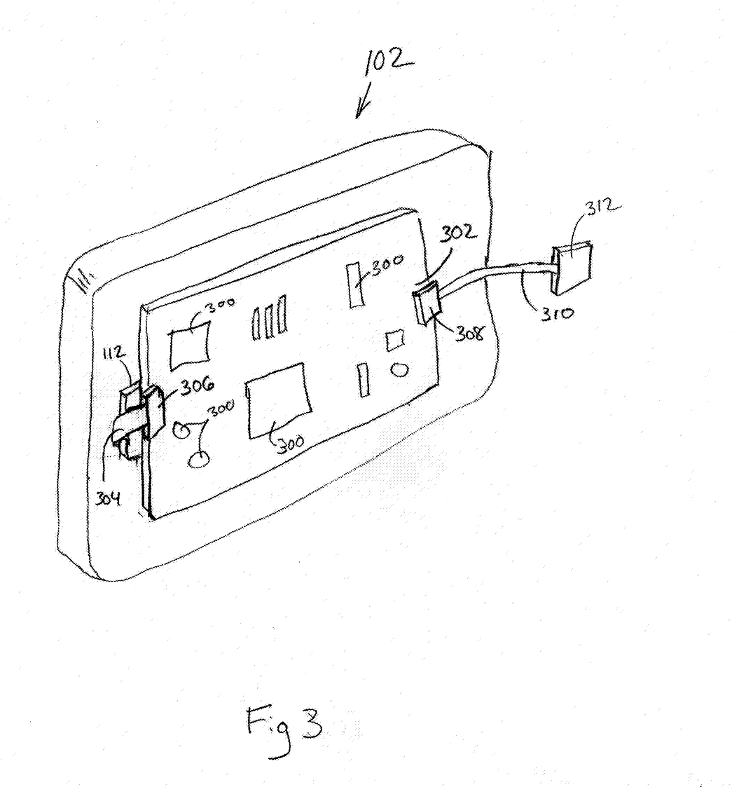

In another embodiment, the electronic signal from mobile computing device 122 is amplified and otherwise controlled by circuitry 300 residing on a circuit board 302 on a rear surface of dashboard insert 102, as shown in FIG. 3. The electronic signal is provided to circuit board 302 via connector 112 (shown in FIG. 3 as being located to connect to a mobile computing device 122 connector directly), cable 304, and connector 306 residing on circuit board 302. The electronic signal is then provided to the circuitry 300 for amplification and other control, such as frequency equalization. Circuitry 300 may comprise discreet electronic components, or a custom ASIC, or a combination of both.

After the electronic signal from mobile computing device 122 has been amplified or otherwise controlled, it is sent out via connector 308 and through cable 310 to a sound system located within the vehicle. The sound system can comprise one or more speakers, an audio amplifier, or a pre-existing electronic device, such as a stereo or a DVD player located within the vehicle.

Circuitry 300 may additionally comprise components necessary to receive AM and/or FM radio signals. Such circuitry is widely available. The AM and/or FM signals are received, amplified and otherwise controlled via circuitry 300, then provided to vehicle speakers or an audio amplifier, as the case may be. Control of the AM/FM radio may be accomplished using a software application resident on mobile computing device 122. In this embodiment, the software application may display a number of options to the vehicle occupant via the mobile computing device 122 display and/or speaker, such as an option to seek or scan radio stations, radio station presets, equalization functions, volume control, etc. The application may be voice controlled via microphone 202 or a microphone resident on mobile computing device 122. As the vehicle occupant selects certain options, representative electronic signals are provided to circuitry 300, where the AM/FM radio may be controlled.

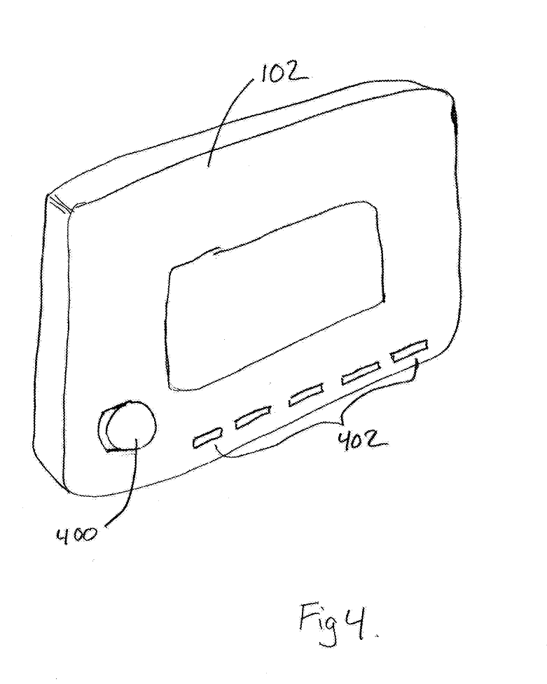

In another embodiment, circuitry 300 may be controlled via one or more knobs, pushbuttons, dials, etc., shown in FIG. 4 as volume control knob 400 and pushbuttons 402. Volume control knob is connected to circuitry 300 to control amplification of the electronic signal and, thus, the eventual volume through the sound system located in the vehicle. Pushbuttons 402 can be assigned any number of pre-designated functions, such as AM/FM frequency selection, radio station pre-sets, equalization functions, etc. The signals from knob 400 and/or pushbuttons 402 may be provided to mobile computing device 122 for use in controlling functionality of one or more applications running on mobile computing device. For example, the signals from pushbuttons 402 may be used by mobile computing device 122 to save presets on an application that receives internet radio. In another embodiment, one or more pushbuttons 402 can be used to control a “search” or “seek” feature of finding desirable internet radio stations on an internet radio application.

Use—Vehicle Diagnostics and Control

In another embodiment, in addition or in the alternative to the vehicle navigation application and media application described above, the assembly 100 can be used to provide vehicle diagnostics and control to, or for, the vehicle.

In this embodiment, one of the circuits 300 on circuit board 302 comprises interface circuitry for allowing communications between mobile computing device 122 and a processor and/or other circuitry resident in the vehicle. The interface circuitry is connected to cable 310 (or another cable) which, in turn, is connected to the existing processor, other circuitry, and/or an existing interface. In another embodiment where circuit board 302 is not used, a cable/wiring harness may run from connector 112 (and/or connectors 114 and 900, depending on implementation) to the resident processor, other circuitry, and/or existing interface. In one embodiment, connector 312 is used to connect to an available on-board diagnostic system, widely available in modern vehicles and known as OBD (on-board diagnostics). OBD, in an automotive context, is a generic term referring to a vehicle's self-diagnostic and reporting capability. OBD systems give the vehicle owner or repair technicians access to state of health information for various vehicle sub-systems. Modern OBD implementations use a standardized digital communications port to provide real-time data in addition to a standardized series of diagnostic trouble codes, or DTCs, which allow one to rapidly identify and remedy malfunctions within the vehicle.

OBD in vehicles has been standardized and has experienced several changes over the years, culminating in a standard version known as OBD-II. Various tools are available that plug in to the OBD connector to access OBD functions. These range from simple generic consumer level tools to highly sophisticated OEM dealership tools. A wide range of rugged hand-held scan tools is available, such as simple fault code readers/reset tools aimed at the consumer level. They may read simple error codes, possibly without translating the meaning, and reset those error codes. Professional hand-held scan tools are also available that may possess more advanced functions than consumer readers, such as the ability to set manufacturer or vehicle-specific ECU (engine control unit) parameters, access and control of other control units such as air bags or ABS (anti-lock braking system), and real-time monitoring or graphing of engine parameters to facilitate diagnosis or tuning.

One or more cables or wiring harnesses may originate from connector 112 and/or connector 312 to connect the mobile computing device 122 to one or more destinations inside the vehicle. For example, one cable or wiring harness can emanate from connector 112 and connect to an audio amplifier resident in the vehicle, while another cable or wiring harness can run between connector 312 and the OBD connector.

A variety of applications may be developed for execution on the mobile computing device 122 that can take advantage of the information provided by the OBD and/or other processors located in or on the vehicle. For example, parameters available via the OBD are addressed by “parameter identification numbers” or PIDs which are defined in SAE standard J1979. The types of information available through the OBD can include fuel level, engine RPM, engine coolant temperature, fuel pressure, vehicle speed, oxygen sensor values, ambient air temperature, turbocharger information, and other information, all available in SAE J1979.

Other information, in addition to what is provided by the OBD, may be used by mobile computing device 122 as well. This additional information may be obtained by running a cable/wiring harness from connectors 112 and/or 312 (and/or connectors 114 and 900), depending on implementation) to a processor, other circuitry, and/or interface circuitry resident in the vehicle that allows mobile computing device 122 to communicate with the processor, other circuitry, and/or interface to provide information such as a vehicle odometer reading, miles or time since the last oil change, miles or time since the last tire rotation, a windshield reservoir level, tire pressure, backup camera information, etc.

Additional information, in addition to what is provided by the OBD and the information described above, may be provided to and used by mobile computing device 122 as well. This additional information may be obtained by running a cable or wiring harness from connector 112 and/or 312 (and/or connectors 114 and 900), depending on implementation) to a processor, other circuitry, cable, wiring harness, or interface relating to other functions provided by the vehicle or aftermarket devices installed in the vehicle, such as a backup camera. The information from the backup camera may comprise video data and/or numerical data, such as the distance between the vehicle and an object.

In one embodiment, a software application residing on mobile computing device 122 receives fuel information from either the OBD or through another processor, circuit, or interface. The fuel information may indicate how much fuel is remaining inside the fuel tank at any given time or how much fuel has been consumed since a previous time interval, distance interval, or event. When the fuel level inside the fuel tank reaches a predetermined level, as indicated by the fuel information, information relating to nearby fuel stations is provided to vehicle occupants. For example, the application may receive periodic indications of a fuel level from the vehicle. When the fuel level indicates only 1/16 of a tank of fuel remaining in the fuel tank, the application may display a map on mobile computing device 122 indicating one or more nearby fuel stations. The map and nearby fuel station information are provided by a GPS and/or mapping application resident on mobile computing device 122, such as the popular Google Maps application.

The software application can also provide an audio or visual alert to vehicle occupants once the predetermined fuel level has been reached. It may also provide information to vehicle occupants indicating a mileage remaining before the vehicle runs out of fuel, a rate of fuel consumption, and/or a fuel efficiency figure (i.e., average or instantaneous mileage per gallon). Mobile computing device 122 can calculate these figures using the fuel information provided by the vehicle.

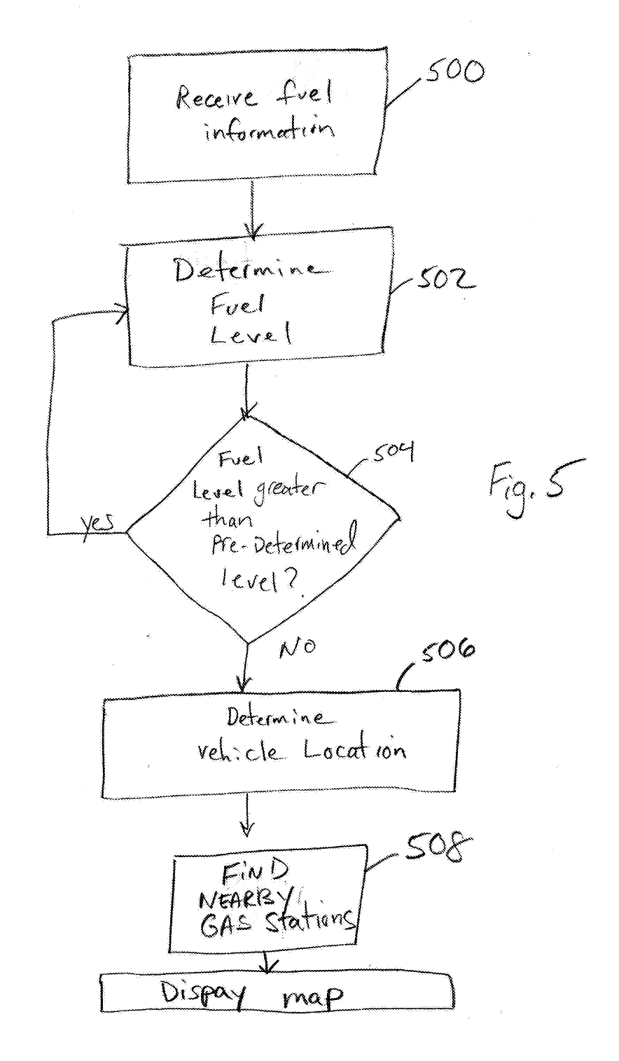

FIG. 5 is a flow chart illustrating such a method for providing a low-fuel application to vehicle occupants. In step 500, fuel information is received by mobile computing device 122 via assembly 100. A software application executed by the mobile computing device 122 determines the fuel level of the vehicle using the received fuel information in step 502. In step 504, the application compares the fuel level to a predetermined fuel level to determine whether the vehicle is getting low on fuel. If the fuel level is greater than the predetermined fuel level, the application returns to receiving new fuel information in step 500. If the fuel level is less than or equal to the predetermined fuel level, then processing continues to step 506, where a vehicle location is determined, typically using a second application, such as a GPS mapping application residing in mobile computing device 122. In step 508, one or more fuel stations within a predetermined distance from the vehicle location are identified, typically using the same GPS mapping application. In step 510, a map is displayed to a vehicle occupant indicating the identified fuel stations nearby. This information is typically provided by displaying a map with the vehicle's position and icons indicating the identified fuel stations. Upon selection of one of the nearby fuel stations, routing instructions may be provided to vehicle occupants.

Alternate Physical Embodiment

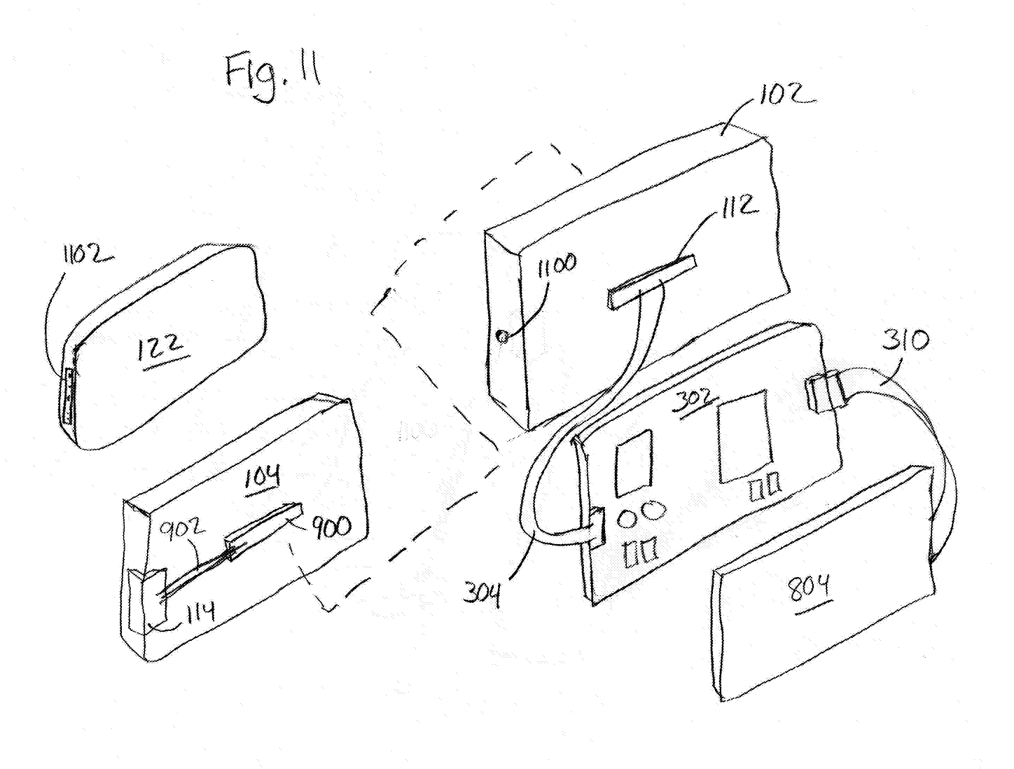

FIG. 6 is a plan view of another embodiment of dashboard insert 102. In this embodiment, dashboard insert 102 is attached to two members 600 which, in turn, are each connected to a gearbox and/or electric motor (shown in FIG. 10 as motor 1000 and gearbox 1002). One example of such an electric motor and gearbox combination is part number Part#0-PL994, offered by www.robotmarketplace.com. In another embodiment only one of the members 600 are connected to a gearbox 1002 and/or motor 1000, while the other shaft comprises either a fixed or rotatable member attached to a rear surface 1004 of dashboard 108 via clamp, ball bearing, rail, inset, or other mechanical fastening means 1006, allowing dashboard insert 104 to rotate around the member. In still another embodiment, one or both electric motors are mounted on dashboard insert 102. In yet still another embodiment, at least one of the members 600 is connected to dashboard insert 102 with an opposing end for connection to a receptacle mounted to dashboard 108. Other physical arrangements, allowing rotation of dashboard insert 102, are possible as well.

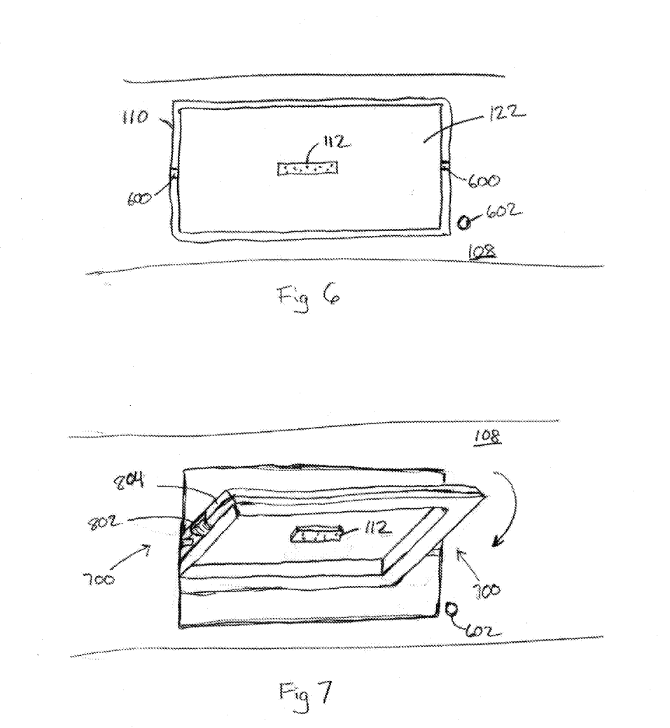

Each member 600 may comprise either a hollow or solid shaft, with either or both connected to a gearbox 1002 and/or electric motor 1000 located behind cutout 110 in dashboard 108, generally behind one or both areas 700 of dashboard 108, as shown in FIG. 7. In an embodiment where one or both members 600 comprise hollow shafts, wiring 902 may be placed inside the hollow shaft so that electronic signals may be passed between connector 112 and circuitry located either on dashboard insert 102 or on circuitry residing in or on the vehicle, such as circuit board 1008 as shown in FIG. 10.

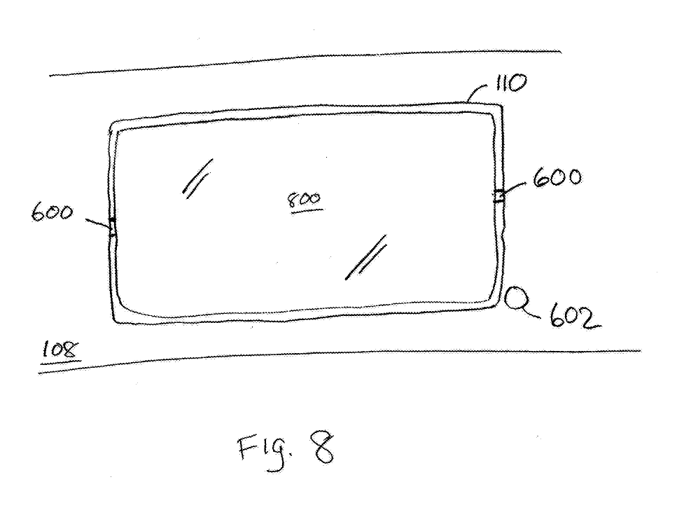

Dashboard insert 102 is able to be rotated from a first position, as shown in FIG. 6, to a second position, as shown in FIG. 8. FIG. 7 illustrates dashboard 102 as it is being rotated from the first position to the second position. Rotation is controlled by a knob, pushbutton, or other well-known control device 602, typically mounted on dashboard 108. The control device 602 is electronically connected to control circuitry as shown in FIG. 10, located behind dashboard 108 or on dashboard insert 102. When control device 602 is activated, the control circuitry energizes one or both electric motors to rotate dashboard 104 approximately 180 degrees, from the first position to the second position. A second activation of control device 602 provides another rotation of approximately 180 degrees, rotating dashboard insert 602 from the second position to the first position.

The rotatable nature of the embodiment shown in FIGS. 6-8 allows assembly 100 and inserted mobile computing device 122 to be rotated approximately 180 degrees, thus hiding mobile computing device 122 and second insert 104 from view while assembly 100 is rotated into the second position. This may be desirable when the mobile communication device 122 is not being used, such as when a vehicle occupant leaves the vehicle for any given time period.

FIG. 8 illustrates a rear portion 800 of dashboard insert 102 while dashboard insert is rotated into the second position. The rear portion 800 may comprise materials that closely match materials comprising dashboard 108 so that rear portion 800 maintains a look of continuity between dashboard 108 and rear portion 800. In another embodiment, rear portion 800 additionally comprises a cover that is attached to dashboard insert 102 that is used to hide circuitry located between rear portion 800 and underneath the cover.

In still another embodiment, a display device 804 is installed to dashboard insert 102 on top of rear portion 800. The display device 804 is used to provide visual information, normally shown on the mobile computing device's 122 display, to vehicle occupants. Display device 804 is connected to the mobile computing device 122 when the mobile computing device is placed into dashboard insert 102 via second insert 104, and connectors 112, 114, and/or 900. The display device is generally larger in area than the display of the mobile computing device 122. In this embodiment, a user may connect mobile computing device 122 into dashboard insert 102/second insert 104 while dashboard insert 102 is in the first position. Dashboard insert 102 may then be rotated into the second position after a vehicle occupant activates control device 602. Electronic signals from mobile computing device 122 may then be sent to the display device, such as electronic signals representing visual information, effectively providing a vehicle occupant with a larger display to view information provided by the mobile computing device 122.

In another embodiment, display device 804 comprises a touch-screen device, such as model number LTA084C272F manufactured by Toshiba Corporation, located in Tokyo, Japan. In this embodiment, mobile computing device 122 may be operated via the display device in addition to simply receiving electronic signals from mobile computing device 122. Electronic signals are generated by the display device when a user touches the display's screen. These electronic signals may be sent to the mobile communication device 122 via connector/cable 802 (shown in FIG. 7), connectors 112, 114, and/or 900 and/or intervening circuitry electronically located between display device 804 and mobile computing device 122. Operation of mobile computing device 122 may, thus, be controlled using the touch screen device. Conversely, electronic signals from mobile computing device 122 may be sent to the touch screen device via the same interfacing hardware. In this way, the user is provided a much larger display than the mobile computer 122, making it easier to utilize the functionality provided by mobile computing device 122.

FIG. 10 illustrates a rear view of dashboard 108.

FIG. 11 illustrates an exploded view of the embodiment comprising display device 804 plus circuitry 300. Shown is display device 804, circuit board 302, dashboard insert 102 (also shown on dashboard insert 102 is receptacle 1100, used to secure a member 600 in one embodiment), second insert 104, and mobile computing device 122, as well as several other features. Also shown is mobile computing device connector 1102, used to connect to connector 114 in one embodiment, or directly to connector 112 in another embodiment.

The methods or steps described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention can include a computer readable media embodying a code or processor-readable instructions to implement the methods of operation of the kiosk in accordance with the methods, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. An apparatus for providing increased vehicle functionality, comprising:
a dashboard insert comprising a recess and an electrical connector; and
a second insert having an external surface substantially matching the recess, the second insert comprising a deformation substantially matching an external surface of a mobile computing device.

2. The apparatus of claim 1 wherein the mobile computing device comprises a smartphone.

3. The apparatus of claim 1 wherein the mobile computing device comprises a tablet computer.

4. The apparatus of claim 1, further comprising a swivel mount attached to the connector and to the deformation.

5. The apparatus of claim 4, wherein the swivel mount further comprises a spring.

6. The apparatus of claim 1, wherein the dashboard insert further comprises:
an amplifier for receiving electronic signals from the mobile computing device and for providing an amplified version of the electronic signals to an existing vehicle sound system.

7. The apparatus of claim 6, further comprising a rotatable knob mounted on the dashboard insert, electrically connected to the amplifier for controlling amplification of the electronic signals.

8. The apparatus of claim 1, further comprising an electronic interface for allowing communications between the mobile computing device and existing vehicle circuitry.

9. The apparatus of claim 1, further comprising a switch, located on a vehicle interior surface, for enabling voice control of applications running on the mobile computing device.

10. The apparatus of claim 1, further comprising:
a control device; and
an electric motor comprising a rotatable shaft, one end of the rotatable shaft connected to the dashboard insert for rotating the dashboard insert upon a user activating the control device.

11. The apparatus of claim 10, further comprising:
a display mounted to a rear portion of the dashboard insert; and
a cable for electronically providing electronic signals from the mobile computing device to the display.

12. The apparatus of claim 11 wherein the display comprises a touch-screen display for controlling operation of the mobile computing device.

13. A method for providing additional functionality to a vehicle, comprising:
installing a dashboard insert into a dashboard, the dashboard insert comprising a recess and an electrical connector; and
securing a second insert to the recess, the second insert having an external surface substantially matching the recess and further comprising a deformation substantially matching an external surface of a mobile computing device.

14. The method of claim 13 further comprising:
connecting the mobile communication device to the connector; and
securing the mobile computing device to the deformation.

15. The method of claim 13 wherein the mobile computing device comprises a smartphone.

16. The method of claim 13 wherein the mobile computing device comprises a tablet computer.

17. The method of claim 13, further comprising:
installing an amplifier for receiving electronic signals from the mobile computing device and for providing an amplified version of the electronic signals to an existing vehicle sound system.

18. The method of claim 17, further comprising:
installing a rotatable knob to the dashboard insert;
electrically connecting the knob to the amplifier for controlling amplification of the electronic signals.

19. The method of claim 13, further comprising:
installing an electronic interface to the dashboard insert for allowing communications between the mobile computing device and existing vehicle circuitry.

20. The method of claim 13, further comprising:
installing a switch to a vehicle interior for enabling voice control of applications running on the mobile computing device.
